(19) United States
(12) Patent Application Publication
(10) Pub. No.: US 2026/0048651 A1
(43) Pub. Date: Feb. 19, 2026

(54) VEHICLE HAVING POWER INVERTER MODULE PROTECTION SHIELD

(71) Applicant: FCA US LLC, Auburn Hills, MI (US)

(72) Inventors: Vikas N Sanghavi, Auburn Hills, MI (US); Milind S Parab, Auburn Hills, MI (US); Ranjit B Pandhare, Auburn Hills, MI (US); Meyyappan Valliappan, Auburn Hills, MI (US); Nikhil Balkrishna Bulbule, Pune (IN)

(21) Appl. No.: 18/805,654

(22) Filed: Aug. 15, 2024

(51) Int. Cl. B60K 6/405; B60K 17/22

(52) U.S. Cl. CPC B60K 6/405; B60K 17/22; B60Y 2200/92; B60Y 2400/61

(57) ABSTRACT

A vehicle including a propulsion system having a drive shaft configured to drive at least one wheel of the vehicle; a powertrain component attached to the propulsion system; a high-voltage component attached to the powertrain component; and a protective shield assembly fixed to the powertrain component in a manner where the high-voltage component is at least partially sandwiched between the protective shield assembly and the powertrain component, wherein the protective shield assembly is configured to protect the high-voltage component from being contacted by the draft shaft.

### FIELD

The present disclosure relates to a vehicle having a power inverter module protection shield.

### BACKGROUND

This section provides background information related to the present disclosure which is not necessarily prior art.

Vehicles are currently being manufactured that may include an internal combustion engine (ICE) drivetrain, a battery-powered drivetrain, or a combination of an ICE drivetrain and battery-powered drivetrain (i.e., hybrid). Because hybrid vehicles include a combination of an ICE drivetrain and a battery-powered drivetrain, hybrid vehicles can be much heavier in comparison to vehicles that include only an ICE drivetrain or a battery-powered drivetrain. This additional mass can lead to components of the hybrid vehicle being exposed to greater forces during a collision event.

Specifically, when some types of hybrid vehicles are subjected to high-speed driver side small overlap (DSORB) impact testing, there may be instances where the forces generated during such an impact are sufficient to cause the structure integrity of a housing of a high-voltage component of the hybrid vehicle to fail. If the housing of the high-voltage component fails, there is a potential for sharp edges to be formed that can damage the sensitive features of the high-voltage component located in the housing, which is undesirable.

### SUMMARY

This section provides a general summary of the disclosure, and is not a comprehensive disclosure of its full scope or all of its features.

According to an aspect, the present disclosure provides a vehicle including a propulsion system having a drive shaft configured to drive at least one wheel of the vehicle; a powertrain component attached to the propulsion system; a high-voltage component attached to the powertrain component; and a protective shield assembly fixed to the powertrain component in a manner where the high-voltage component is at least partially sandwiched between the protective shield assembly and the powertrain component; wherein the protective shield assembly is configured to protect the high-voltage component from being contacted by the draft shaft.

According to the aspect, the protective shield assembly includes a first shield and a second shield.

According to the aspect, each of the first shield and the second shield include a main body having a plurality of outwardly extending flanges configured for receipt of a fastener that fix the protective shield assembly to the drivetrain component.

According to the aspect, each of the first shield and the second shield include at least one reinforcing rib.

According to the aspect, the first shield includes a cylindrical spacer that projects outward therefrom in a direction toward the high-voltage component that maintains a spacing between the high-voltage component and the first shield.

According to the aspect, the first shield is positioned between the drive shaft and the high-voltage component.

According to the aspect, the second shield is positioned between the drivetrain component and the ground.

According to the aspect, the high-voltage component is an inverter.

According to the aspect, the powertrain component is a transmission.

According to the aspect, the propulsion system includes each of an internal combustion engine and an electric drive module.

According to the aspect, the protective shield assembly is formed of a rigid metal material.

According to the aspect, the first shield is fixed to the second shield.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is an overhead perspective view of an example vehicle according to a principle of the present disclosure, with the vehicle body removed from the frame;

FIG. 2 is an isometric perspective view of a powertrain component of the vehicle illustrated in FIG. 1 having a high-voltage component and protective shield assembly according to the present disclosure attached thereto;

FIG. 3 is a side-perspective view of the powertrain component illustrated in FIG. 2 positioned relative to a drive shaft of the vehicle;

FIG. 4 is a bottom perspective view of the powertrain component positioned relative to a drive shaft of the vehicle illustrated in FIG. 3;

FIG. 5 is a bottom perspective view of the vehicle during a collision event that forces the drive shaft into contact with the protective shield assembly rather than high-voltage component attached to the drivetrain component;

FIG. 6 is a perspective view of the powertrain component having the high-voltage component attached thereto without protection being provided by the protection shield assembly, illustrating damage that can be caused by contact between the drive shaft and the high-voltage component;

FIG. 7 is an isometric perspective view of the protective shield assembly according to a principle of the present disclosure; and

FIG. 8 is another isometric perspective view of the protective shield assembly according to a principle of the present disclosure.

Corresponding reference numerals indicate corresponding parts throughout the several views of the drawings.

### DETAILED DESCRIPTION

Example embodiments will now be described more fully with reference to the accompanying drawings. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

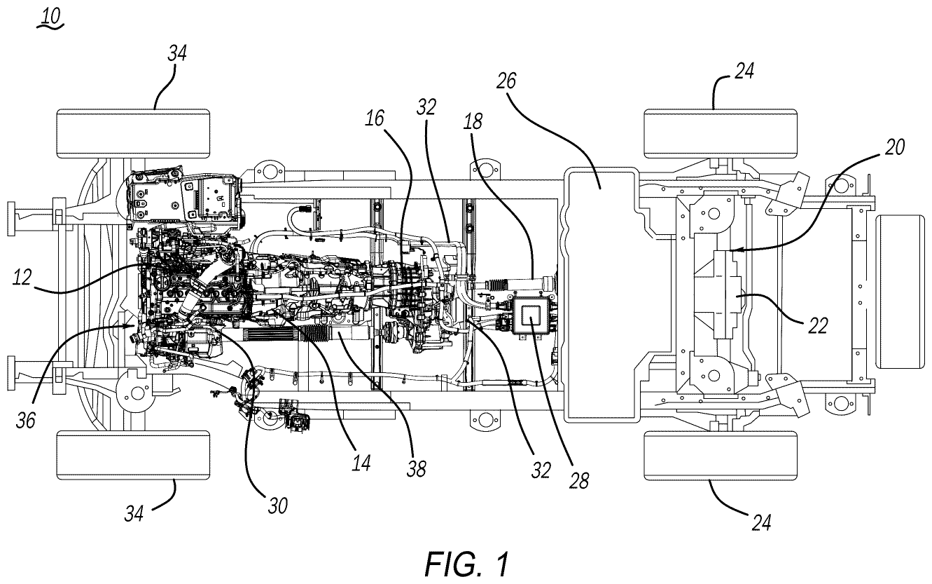

FIG. 1 schematically illustrates a vehicle 10 according to a principle of the present disclosure. Vehicle 10 includes an internal combustion engine (ICE) 12, a powertrain component such as a transmission 14 attached to the ICE 12, a transfer case 16 attached to transmission 14, a first drive shaft 18 attached to transfer case 16, a rear axle assembly 20 including a rear differential 22 attached to first drive shaft 18 that transfers rotation of first drive shaft 18 to at least one of a pair of rear wheels 24 that are attached to the rear axle assembly 20.

Vehicle 10 additionally includes a battery pack 26 that houses a plurality of battery cells (not shown) that can provide electric power to a first high-voltage component 28 such as, for example, an inverter. High voltage component 28 can be connected to various other components of vehicle 10 such as an electric drive module 30 using high-voltage cables 32. Electric drive module 30 can be used to drive, for example, at least one of a pair of front wheels 34 that are connected to a front axle assembly 36. Alternatively or in addition to, electric drive module 30 can be used to drive at least one of the pair of rear wheels 24 via a second drive shaft 38 that is attached to transfer case 16.

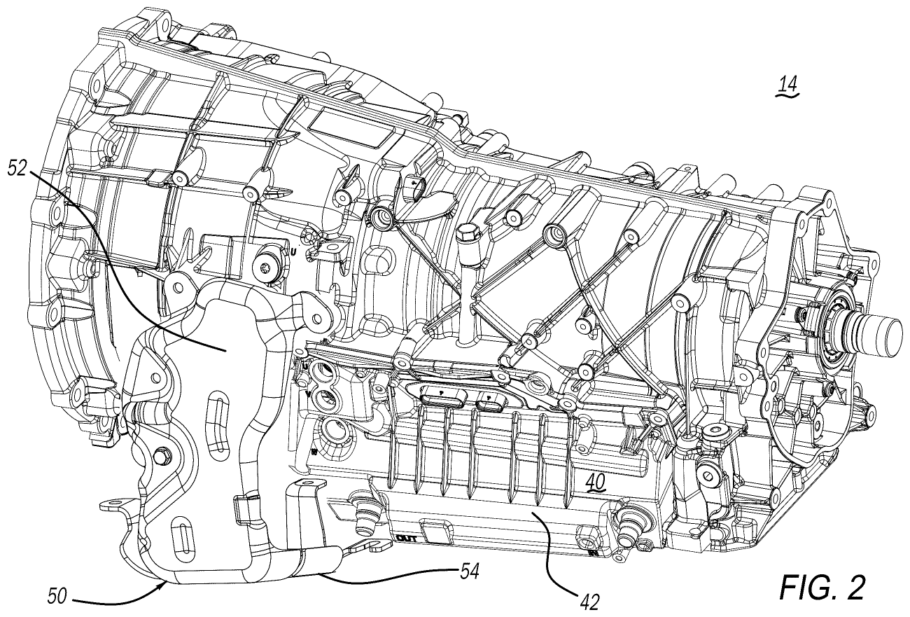

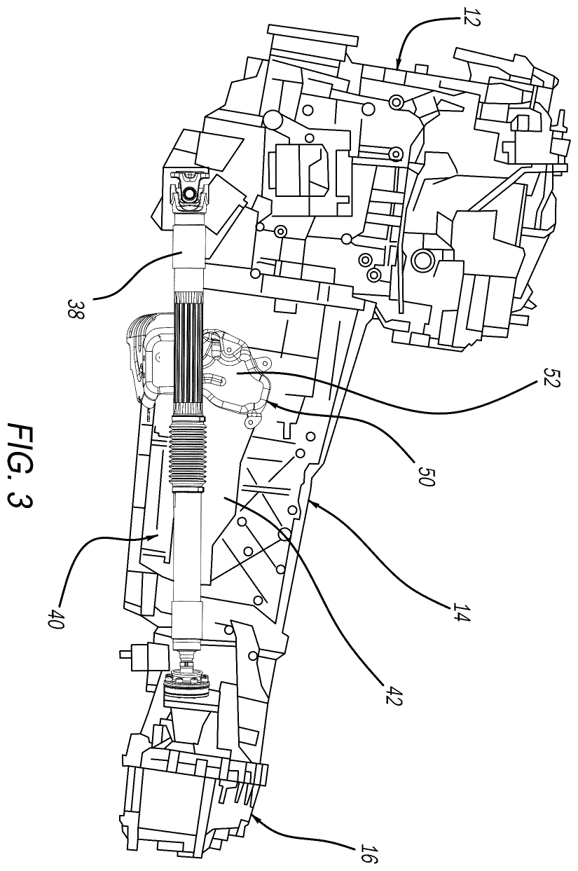

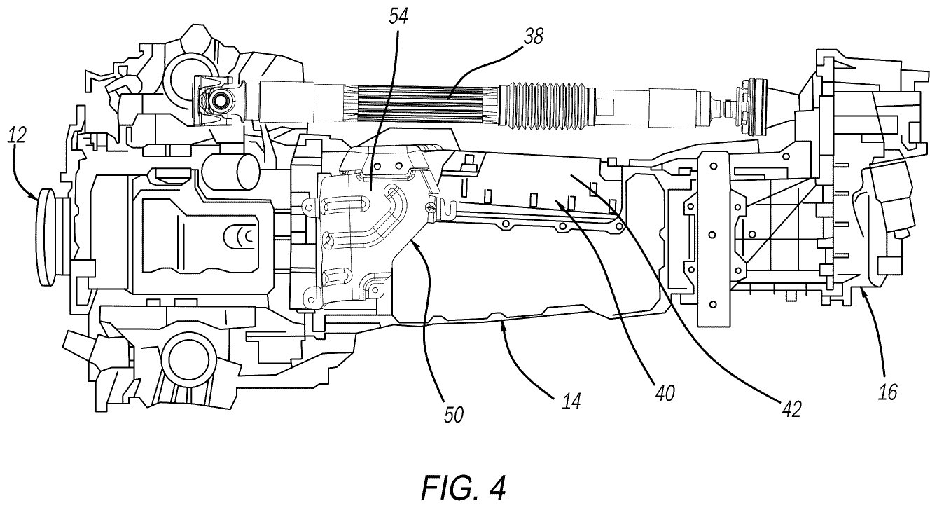

First high-voltage component 28 is one of a plurality of high-voltage components that may be present in vehicle 10. For example, as can be seen in FIGS. 2-4, a second high-voltage component 40 may be attached to transmission 14 on a side of transmission 14 that faces second drive shaft 38. Put another way, second high-voltage component 40 may be located radially outward from second drive shaft 38. Second high-voltage component 40 may be another inverter or may be another type of high-voltage component. Regardless, second high-voltage component 40 includes a housing 42 that encases various electronic features of the second high-voltage component 40, and is fixed to transmission 14 using various fasteners such as bolts (not shown). Housing 42 may be formed of a rigid metal material such as steel, aluminum, or any other type of rigid material (including, for example, rigid polymeric materials) that are known to one skilled in the art.

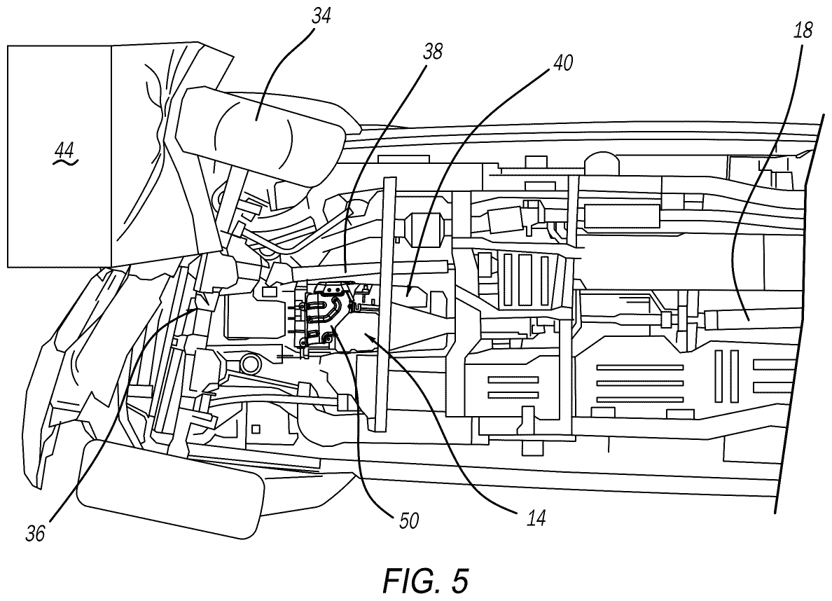

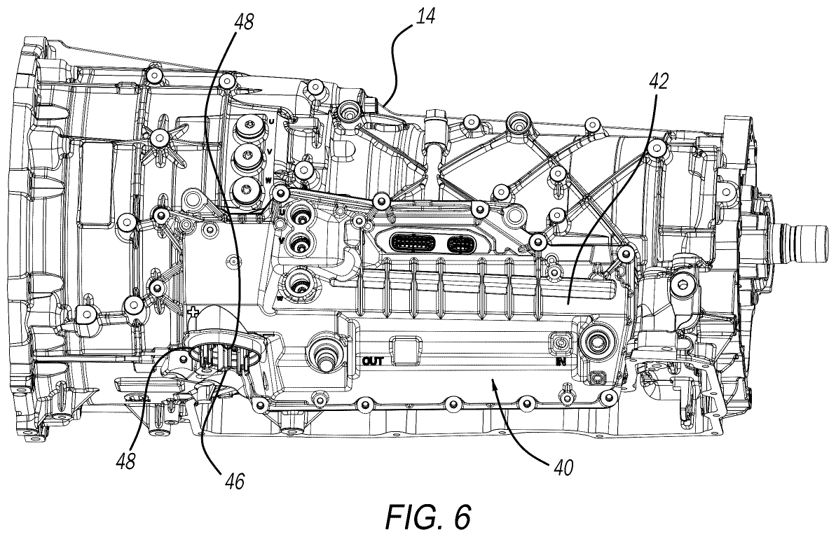

In the event that vehicle 10 is involved in a collision with a barrier 44 or some other type of object (e.g., another vehicle) during, for example, a high-speed driver side small overlap (DSORB) impact (FIG. 5), the force of the collision with barrier 44 can be transferred to second drive shaft 38 and cause the second drive shaft 38 to move both axially back toward transfer case 16 as well as radially in a direction second high-voltage component 40. If the forces experienced during the impact are of sufficient magnitude where second drive shaft 38 contacts the housing 42 of second high-voltage component 40, the force transferred by second drive shaft 38 to housing 42 may cause housing 42 of second high-voltage component to fracture or shatter (FIG. 6). In such a case, portions 46 of the metal housing 42 can form sharp edges 48 that can potentially cut, sever, or damage any high-voltage components (not shown) located within housing 42. Accordingly, it is not desirable for housing 42 to be damaged by second drive shaft 38 in the event of a frontal impact.

Thus, to prevent or at least substantially minimize damage to second high-voltage component 40, a protective shield assembly 50 is attached to transmission 14 in a manner where at least a portion of housing 42 that may be prone to contact with second drive shaft 38 during a collision event is sandwiched between protective shield assembly 50 and transmission 42, as best shown in FIGS. 2-5, 7, and 8. Protective shield assembly 50 may include a first shield 52 and a second shield 54, and each of the first shield 52 and the second shield 54 may be formed of a rigid metal material such as steel, aluminum, or any other type of metal material known to one skilled in the art. A thickness of each shield 52, 54 48 can range between 2 mm to 5 mm. While protective shield assembly 50 will be further described below as being a two-piece assembly, it should be understood that first and second shields 52 and 54 may be combined to form a monolithic member without departing from the scope of the present disclosure. It should be noted, however, that the two-piece assembly shield assembly 50 may be easier to install on vehicle 10.

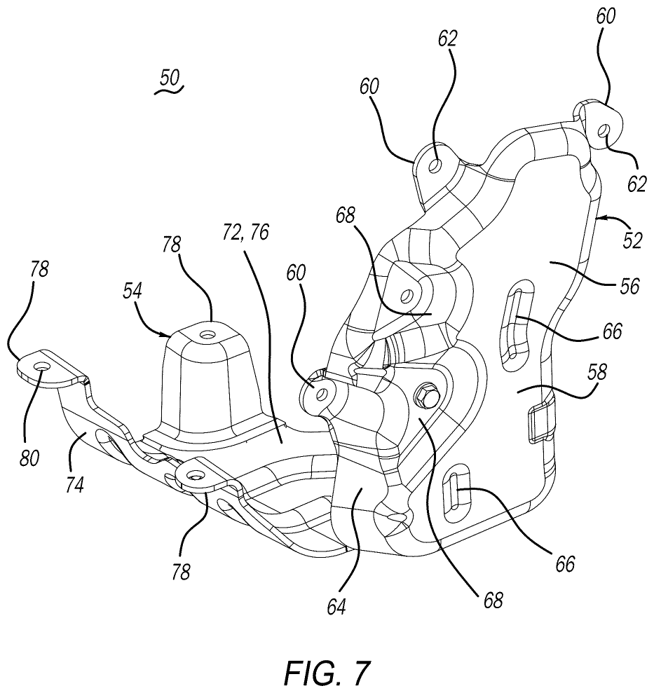

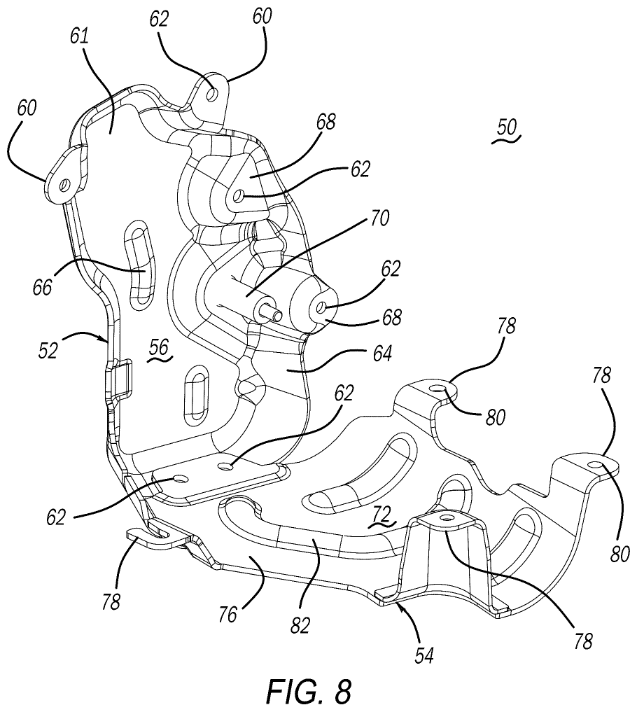

In the illustrated embodiment shown in FIGS. 7 and 8, first shield 52 includes a first main body 56 having an exterior surface 58 and an interior surface 61, with exterior surface 58 being configured to be potentially contacted by second drive shaft 38 during a collision event. That is, first shield 52 is attached to transmission 14 directly between second high-voltage component 40 and transmission 14. A plurality of first tabs or flanges 60 extend outward from first main body 56 that each include an aperture 62 configured for receipt of a fastener (not shown) that may be used to attach first shield 52 to transmission 14. First shield 52 may also include a collar 64 that extends along an edge of main body 56, a plurality of first strengthening ribs 66, and various cup-shaped recesses 68 that also have apertures 62 configured for receipt of a fastener that may be used to attach first shield 52 to transmission 14. Cup-shaped recesses 68 enable first main body 56 to be spaced apart from second high-voltage component 40 and increase the rigidity of first shield 52. In addition, a rigid cylindrical spacer 70 may be fixed to main body 56 that extends outward therefrom in a direction toward second high-voltage component 40. Spacer 70 is designed to maintain, at least to an extent, the spacing between first shield 52 and second high-voltage component 40 during a collision event between second drive shaft 38 and first shield 52. Put another way, spacer 70 may be used to reduce the loading on second high-voltage component 40 during a collision event between second drive shaft 38 and first shield 52. To attach first shield 52 to second shield 54, collar 64 may include a pair of the apertures 62 that align with apertures (not shown) formed on second shield 54 that are configured for receipt of a fastener (not shown) such as a rivet or bolt.

Second shield 54 includes a second main body 72 having an exterior surface 74 and an interior surface 76, with exterior surface 74 being configured to be potentially contacted by an obstacle or some other type of object located beneath vehicle 10. That is, second shield 54 is attached to an underside of transmission 14 directly between the ground and transmission 14. A plurality of second tabs or flanges 78 extend outward from second main body 72 that each include an aperture 80 configured for receipt of a fastener (not shown) that may be used to attach second shield 54 to transmission 14. Second shield 54 may also include a plurality of second strengthening ribs 82.

It should be understood that the overall shapes and configurations of first shield 52 and second shield 54 are variable, and can be designed based on the configuration of transmission 14 and the configuration of housing 42 of the second high-voltage component 40. The primary aspect to keep in mind is that shield assembly 50 is designed to protect second high-voltage component 40 that may be attached to transmission 14 from being struck by either second drive shaft 38 during a collision event that forces second drive shaft 38 in a direction toward second high-voltage component 40, or some other obstacle located beneath vehicle 10 that vehicle 10 has travelled over. Thus, the shape and number of first flanges 60, second flanges 78, first and second strengthening ribs 66 and 82, and cup-shaped recesses 68 are each variable.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A vehicle comprising:
a propulsion system having a drive shaft configured to drive at least one wheel of the vehicle;
a powertrain component attached to the propulsion system;
a high-voltage component attached to the powertrain component; and
a protective shield assembly fixed to the powertrain component in a manner where the high-voltage component is at least partially sandwiched between the protective shield assembly and the powertrain component;
wherein the protective shield assembly is configured to protect the high-voltage component from being contacted by the draft shaft.

2. The vehicle according to claim 1, wherein the protective shield assembly includes a first shield and a second shield.

3. The vehicle according to claim 2, wherein each of the first shield and the second shield include a main body having a plurality of outwardly extending flanges configured for receipt of a fastener that fix the protective shield assembly to the drivetrain component.

4. The vehicle according to claim 2, wherein each of the first shield and the second shield include at least one reinforcing rib.

5. The vehicle according to claim 2, wherein the first shield includes a cylindrical spacer that projects outward therefrom in a direction toward the high-voltage component that maintains a spacing between the high-voltage component and the first shield.

7. The vehicle according to claim 2, wherein the first shield is positioned between the drive shaft and the high-voltage component.

8. The vehicle according to claim 7, wherein the second shield is positioned between the drivetrain component and the ground.

9. The vehicle according to claim 1, wherein the high-voltage component is an inverter.

10. The vehicle according to claim 1, wherein the powertrain component is a transmission.

11. The vehicle according to claim 1, wherein the propulsion system includes each of an internal combustion engine and an electric drive module.

12. The vehicle according to claim 1, wherein the protective shield assembly is formed of a rigid metal material.

13. The vehicle according to claim 2, wherein the first shield is fixed to the second shield.
